(19) United States
(12) Patent Application Publication
(10) Pub. No.: US 2014/0236705 A1
(43) Pub. Date: Aug. 21, 2014

(54) METHOD AND APPARATUS FOR DATA-DRIVEN MULTI-TOUCH ATTRIBUTION DETERMINATION IN MULTICHANNEL ADVERTISING CAMPAIGNS

(71) Applicant: TURN INC., Redwood City, CA (US)

(72) Inventor: Xuhui SHAO, Palo Alto, CA (US)

(73) Assignee: TURN INC., Redwood City, CA (US)

(21) Appl. No.: 13/769,075

(22) Filed: Feb. 15, 2013

(51) Int. Cl. G06Q 30/02

(52) U.S. Cl. CPC G06Q 30/0242
USPC 705/14.41

(57) ABSTRACT

A bivariate metric is disclosed, in which one variable measures the variability of the estimate, and the other measures the accuracy of classifying the positive and negative users. A bagged logistic regression model is used, which achieves a comparable classification accuracy as a usual logistic regression, but a much more stable estimate of individual advertising channel contributions. Embodiments of the invention also provide an intuitive and simple probabilistic model to quantify the attribution of different advertising channels directly. Both the bagged logistic model and the probabilistic model are then applied to a real world data set from a multichannel advertising campaign.

### BACKGROUND OF THE INVENTION

1. Technical Field

The invention relates to digital advertising. More particularly, the invention relates to data-driven multi-touch attribution models for use in connection with digital advertising.

2. Description of the Background Art

Digital advertising started about 16 years ago as a new medium where traditional print ads can appear (see D'Angelo, F., Happy Birthday, Digital Advertising! (2009) http://adage.com/digitalnext/post?article_id=139964). As the Internet continues to grow, the advertising industry has embraced digital advertising and has made it a $40 billion a year mega-industry in US alone. Digital advertising's appeal is not only in its ability to target different groups of consumers precisely with customized ad messages and ad placements, but probably more importantly in its ability to track responses and performance almost instantaneously.

Advertising campaigns are often launched across multiple channels. Traditional advertising channels include outdoor billboard, TV, radio, newspapers and magazines, and direct mailing. Digital advertising channels include search, online display, social, video, mobile, and email.

Typically, multiple advertising channels have delivered advertisement impressions to a user. When a user then makes a purchase decision or signs up to a service being advertised, the advertiser wants to determine which ads have contributed to the user's decision. This step is critical in completing the feedback loop so that one can analyze, report, and optimize an advertising campaign. The problem of interpreting the influence of specific advertisement impressions on the user's decision process is called the attribution problem.

The goal of attribution modeling is to pinpoint the credit assignment of each positive user to one or more advertising touch points, which is illustrated in FIG. 1. The resulting user level assignment can be aggregated along different dimensions, including the media channel, to derive overall insights. Attribution modeling is not to be confused with marketing mix modeling (MMM), which is limited to the temporal analysis of marketing channels and can not perform any inference at the user level or any dimensions other than the marketing channel.

To determine which media channel or which ad is to be credited, initially a simple rule was developed and quickly adopted by the online advertising industry:
The last ad the user clicked on before he made the purchase or sign up decision, or say, conversion, gets 100% of the credit.

This “last click win” model was extended to include “last view win” if none of the ads was clicked within a reasonable time window before user conversion. For purposes of the discussion herein, both these two models are referred to as “last touch attribution” (LTA), where “touch” or touch point is defined to be any ad impression, click, or advertising related interaction the user has experienced from the advertiser. The last touch attribution model is simple. However, it completely ignores the influences of all ad impressions, except the last one. It is a highly flawed model as pointed out by Chandler Pepelnjak, J. Atlas Institute, Microsoft Advertising, Measuring ROI Beyond the Last Ad, http://www.atlassolutions.com/uploadedFiles/Atlas/Atlas_Institute/Published_Content/dmiMeasuringROIBeyondLastAd.pdf.

Alternatively, the concept of the multi touch attribution (MTA) model has been recently proposed, where more than one touch point can each have a fraction of the credit based on the true influence each touch point has on the outcome, i.e. user's conversion decision. Atlas Institute, a division of Microsoft Advertising first proposed the notion of MTA (supra). However, in that paper and other related research from Microsoft Atlas, there is no proposal for how to assign the percentage of credit statistically based on the campaign data. Clearsaleing is a consulting company specialized in attribution analysis, whose attribution model assigns an equal fraction of credits to the first and the last touch point, and collectively all the touch points in between (see Clearsaleing Inc., Clearsaleing Attribution Model, http://www.clearsaleing.com/product/accurateattributionmanagement/). While a data-driven custom model is described as available upon request, the methodology of the custom model is not publicized. Another company, C3Metric, also offers a rule-based MTA model (see C3 Metric, Inc., What is C3 Metric, http://c3metrics.com/executivesummary/). But as with Clearsaleing, their model assigns credit to certain touch points simply based on the temporal order of touch points and with fixed percentages. Because the user's decision process is largely dependent on the advertiser, the product offer, and how advertising messages and creative design are structured, a desirable attribution model should be campaign specific and be driven by a solid statistical analysis of user response data. In addition to the lack of a true data driven MTA model, a good metric to evaluate different MTA models is not available either. Intuitively, a good MTA model should have a high degree of accuracy in correctly classifying a user as positive (with a conversion action) or negative (without a conversion action). Equally or more important in digital advertising is that, a good MTA model should provide a stable estimation of an individual variable's (for example, media channel) contribution. Unlike predictive models, the stability of the estimation is especially important here because attribution model determines the performance metric for the ad campaign. Every advertising company and every advertising tactic is ultimately judged by the performance metric set forth in the attribution model. Having a stable and reproducible result is by definition what a performance metric needs to be. Ideally the attribution model should be easy to interpret because the results of attribution analysis are often used to derive insights to the ad campaign and its optimization strategy.

Although in recent years predictive modeling has been thoroughly researched in the digital advertising domain, for example in Provost, F., Dalessandro, B., Hook, R., Zhang, X., and Murray, A., Audience Selection for Online Brand Advertising: Privacy friendly Social Network Targeting, Proceedings of the Fifteenth ACM SIGKDD International Conference on Knowledge Discovery and Data Mining, (2009); and Li, W., Wang, X., Zhang, R., Cui, Y., Mao, J., and Jin, R., Exploitation and Exploration in a Performance Based Contextual Advertising System, Proceedings of the Fifteenth ACM SIGKDD International Conference on Knowledge Discovery and Data Mining (2010), the focus has been on the classification accuracy. The resulting models, many generated from a black box type predictive approach, are very hard to interpret. Furthermore, little attention has been paid to the stability issue of the variable contribution estimate. There is also the problem of variable correlation when one tries to interpret the model coefficients directly, which was discussed in Hastie, T., Tibshirani, R., and Friedman, J., The Elements of Statistical Learning: Data Mining, Inference and Prediction, 2nd Edition, Springer, New York, section 4.4.2 (2009).

### SUMMARY OF THE INVENTION

Embodiments of the invention provide a bivariate metric, where one variable measures the variability of the estimate, and the other measures the accuracy of classifying the positive and negative users. A bagged logistic regression model is used, which achieves a classification accuracy that is comparable to a usual logistic regression, but that is a much more stable estimate of individual advertising channel contributions. Embodiments of the invention also provide an intuitive and simple probabilistic model to quantify the attribution of different advertising channels directly. Both the bagged logistic model and the probabilistic model are applied to a real world data set, e.g. from a multichannel advertising campaign. The two models produce consistent general conclusions and thus offer useful cross validation.

### BRIEF DESCRIPTION OF THE DRAWINGS

FIG. 1 is an illustration of the multi-touch attribution problem;

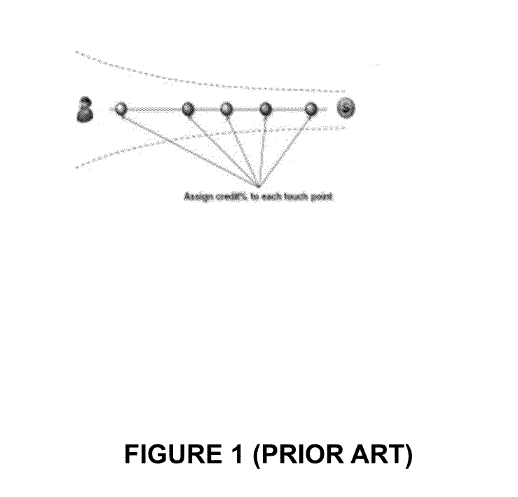

FIG. 2 is a flow diagram showing a bivariate metric according to the invention;

FIG. 3 is a flow diagram showing a bagged logistic regression according to the invention;

FIG. 4 provides a graphic representation of MTA user level assignment for a bagged logistic regression model and a simple probabilistic model according to the invention; and

FIG. 5 is a block schematic diagram that depicts a machine in the exemplary form of a computer system within which a set of instructions for causing the machine to perform any of the herein disclosed methodologies may be executed.

### DETAILED DESCRIPTION OF THE INVENTION

As discussed above, in digital advertising “attribution” is the problem of assigning credit to one or more advertisements for driving the user to the desirable actions, such as making a purchase. Rather than giving all the credit to the last ad a user sees, multi-touch attribution allows more than one ad to get the credit based on each ad's corresponding contributions. Multi-touch attribution is one of the most important problems in digital advertising, especially when multiple media channels, such as search, display, social, mobile, and video are involved. Due to the lack of statistical framework and a viable modeling approach, true data driven methodology does not exist today in the industry. While predictive modeling has been thoroughly researched in recent years in the digital advertising domain, the attribution problem focuses more on accurate and stable interpretation of the influence of each user interaction to the final user decision, rather than just user classification. Traditional classification models fail to achieve these goals.

Embodiments of the invention provide a bivariate metric, where one variable measures the variability of the estimate, and the other measures the accuracy of classifying the positive and negative users. A bagged logistic regression model is used, which achieves a classification accuracy that is comparable to that of a usual logistic regression, but which provides a much more stable estimate of individual advertising channel contributions. Embodiments of the invention also provide an intuitive and simple probabilistic model to quantify the attribution of different advertising channels directly. The simple and intuitive probabilistic model is used to compute the attribution of different variables based on a combination of first and second order conditional probabilities. Both the bagged logistic model and the probabilistic model were applied to a real world data set from a multichannel advertising campaign. In one case, a large advertising campaign data set, which has 72.5 million anonymous users with over two billion ad impressions coming from search, display, social, email, and video channels was analyzed over a four week period. Based on such analysis, the two models produce consistent general conclusions and, in an embodiment of the invention, offer useful cross validation.

### A Bivariate Metric

It is always of interest to identify if a user is to make a purchase or sign up for a service based on his exposure to various advertisement channels. This is a typical classification problem, where the outcome is binary, in which positive means that a user is to make a purchase action and negative means otherwise, and the covariates are the number of touch points of different channels. Towards that end, embodiments of the invention employ the usual misclassification error rate as part of an evaluation metric for an MTA model.

On the other hand, human behavior is complex and the user data are highly correlated. As a consequence, a simple MTA model, e.g. a usual logistic regression, has a highly variable estimate which makes the model difficult to interpret. In addition, the high co-linearity in attributes also causes strong variables to suppress weaker, correlated variables (Hastie et al, supra). Therefore, embodiments of the invention capture the variability of an MTA model in a model evaluation metric. Towards that goal, the notion of standard deviation is employed and advantage is taken of the fact that the advertising campaign data almost always have a large number of users.

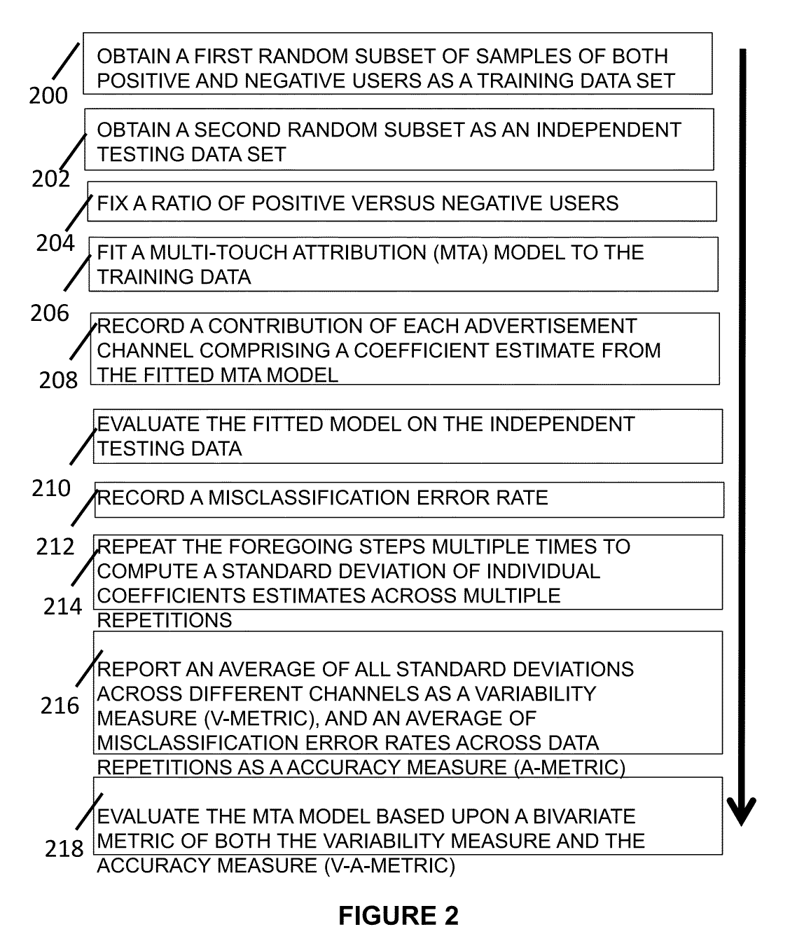

More specifically (see FIG. 2), a random subset of samples of both positive and negative users is first obtained (200) as a training data set, and then another random subset is obtained as a testing data set (202). To avoid having too few positive users in the samples, the ratio of positive versus negative users is fixed (204). In a presently preferred numerical analysis, this ratio is 1:1 and 1:4 and the two ratios yield very similar results. An MTA model is then fit to the training data (206). The contribution of each advertisement channel, i.e. the coefficient estimate, from the fitted MTA model is recorded (208). The fitted model is evaluated on the independent testing data (210) and the misclassification error rate is recorded (212).

The above process is repeated multiple times (214) to compute the standard deviation of individual coefficient estimates across multiple repetitions. The average of all standard deviations across different channels as the variability measure (V-metric), and the average of misclassification error rates across data repetitions as the accuracy measure (A-metric) is reported (216). An MTA model is evaluated (218) based upon the bivariate metric of both the variability and the accuracy (the V-A-metric). A small A-metric indicates that the model under investigation has a high accuracy of predicting the active or inactive user, while a small V-metric indicates that the model has a stable estimate. Ideally, a good MTA model should have both metrics small.

### Multitouch Attribution Models

### A Bagged Logistic Regression

There has been intensive research on classification modeling in the literature. Some well known examples include support vector machines (see Cortes, C., and Vapnik, V, Support Vector Networks, Machine Learning, 20, 273297, (1995)), neural networks (see Bishop, C. M., Neural Networks for Pattern Recognition, Oxford University Press, (1996)), and other unique methods designed for online advertising in Li, W., Wang, X., Zhang, R., Cui, Y., Mao, J., and Jin, R., Exploitation and Exploration in a Performance Based Contextual Advertising System, Proceedings of the Fifteenth ACM SIGKDD International Conference on Knowledge Discovery and Data Mining (2010); and Jin, X., Li, Y., Mah, T., and Tong, J., Sensitive Webpage Classification for Content Advertising, Proceedings of the 1st international workshop on Data mining and audience intelligence for advertising (2007). See, also, Hastie, T., Tibshirani, R., and Friedman, J., The Elements of Statistical Learning: Data Mining, Inference and Prediction, 2nd Edition, Springer, New York (2009); Bishop, C. M., Neural Networks for Pattern Recognition, Oxford University Press (1996); and Bishop, C. M., Pattern Recognition and Machine Learning, Springer (2007). Most of those methods generate a complex model, some of which are of a black box type. The resulting classification boundary is rather flexible, so it can achieve a competent classification accuracy. However, in attribution modeling, it is more of a concern to obtain a model that is stable and relatively easy to interpret, so that advertisers can develop a clear strategy to optimize their resource allocation and optimization among multiple advertising channels.

The bagging approach as a meta learning method was first proposed in Breiman, L., Bagging Predictors, Machine Learning, 24, 123140 (1996). One of the most popular bagged approaches is random forest (see Breiman, L., Random Forests, Machine Learning, 45, 532 (2001)), where decision tree models are stacked to increase performance and robustness. Bagged logistic regression is not of much interest in terms of predictive modeling because it is more productive to combine nonlinear models to increase the prediction accuracy. It has been shown to be outperformed by the tree-based method (see Perlich, C I, Provost, F., and Simonoff, J. S., Tree Induction vs. Logistic Regression: A Learning Curve Analysis, Journal of Machine Learning Research, 4, 211255 (2003)). On the other hand, the bagging approach possesses the ability to isolate variable co-linearity, as discussed in Hastie supra.

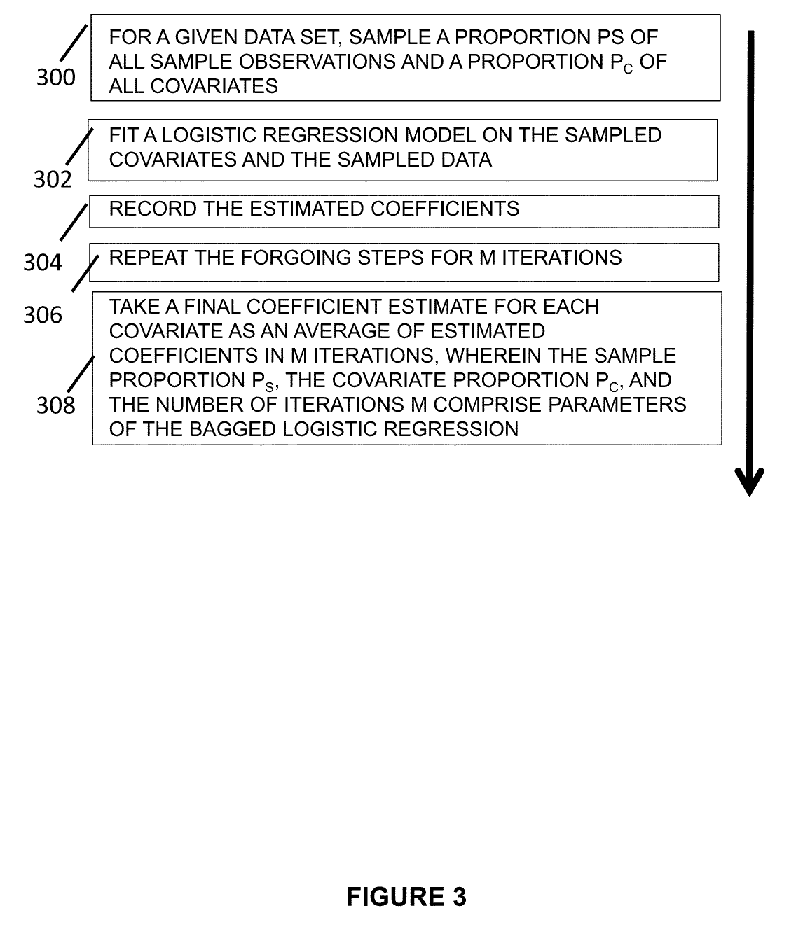

In the context of attribution modeling, we combine the commonly used logistic regression, which is simple and easy to interpret, and the bagging technique, which helps reduce the estimation variability due to the highly correlated covariates. This results in the bagged logistic regression, which retains the ease of interpretation of a simple logistic model, while achieving a stable and reproducible estimation result. More specifically, the bagged logistic regression is fitted using the following steps (see FIG. 3).

Step 1. For a given data set, sample a proportion pₛ of all the sample observations and a proportion p_{c} of all the covariates (300). Fit a logistic regression model on the sampled covariates and the sampled data (302). Record the estimated coefficients (304).
Step 2. Repeat Step 1 for M iterations (306), and the final coefficient estimate for each covariate is taken as the average of estimated coefficients in M iterations (308). The sample proportion pₛ, the covariate proportion p_{c}, and the number of iterations M are the parameters of the bagged logistic regression.

For a range of values of pₛ and p_{c} that are not close to either 0 or 1, the bagged logistic regression yields similar results. Besides, the results are not overly sensitive to the choice of M. When evaluating the model using the proposed V-A-metric, the bagged logistic regression achieves a very similar misclassification rate (A-metric) but enjoys a much smaller variability (V-metric) compared to a usual logistic regression, which is desirable for attribution modeling.

### A Simple Probabilistic Model

In addition to the bagged logistic regression model, we also develop a probabilistic model based on a combination of first and second order conditional probabilities. This new model is even simpler than a logistic model. Such a model simplicity translates into both low estimation variability and ease of interpretation, meanwhile it trades off accuracy. As such, compared to the bagged logistic model, the new model achieves a smaller V-metric, but a larger A-metric. The probabilistic model is generated using the following steps:

Step 1. For a given data set, compute the empirical probability of the main factors,

$$P ( y \vert {x}_{i} ) = \frac{{N}_{positive} ( {X}_{i} )}{{N}_{positive} ( {X}_{i} ) + {N}_{negative} ( {X}_{i} )} \qquad ( 1 )$$

and the pairwise conditional probabilities,

$$P ( y \vert {x}_{i} {x}_{j} ) = \frac{{N}_{positive} ( {x}_{i} , {x}_{j} )}{{N}_{positive} ( {x}_{i} , {x}_{j} ) + {N}_{negative} ( {x}_{i} , {x}_{j} )} \qquad ( 2 )$$

for i≠j.

Here, y is a binary outcome variable denoting a conversion event (purchase or signup), and xᵢ, i=1, . . . , p, denote p different advertising channels. Nₚₒₛᵢₜᵢᵥₑ(xᵢ) and N_{negative}(xᵢ) denote the number of positive or negative users exposed to channel i, respectively, and Nₚₒₛᵢₜᵢᵥₑ(xᵢ, xⱼ) and N_{negative}(xᵢ, xⱼ) denote the number of positive or negative users exposed to both channels i and j.

Step 2. The contribution of channel i is then computed at each positive user level as:

$$C ( {x}_{i} ) = p ( y \vert {x}_{i} ) + \frac{1}{2 {N}_{j \neq i}} {\sum }_{j \neq i} \{ p ( y \vert {x}_{i} , {x}_{j} ) - p ( y \vert {x}_{i} ) - p ( y \vert {x}_{j} ) \} \qquad ( 3 )$$

where Nⱼ≠i denotes the total number of j's not equal to i. In this case it is equal to N−1, or the total number of channels minus one (the channel i itself) for a particular user.

The model is essentially a second order probability estimation. Due to the similarly designed advertising messages and user's exposure to multiple media channels, there is a fair amount of overlapping between the influences of different touch points. Therefore, it is critically important to include the second order interaction terms in the probability model. In other embodiments, one can go to the third order and fourth order interactions, or higher. However, the number of observations with the same third order interaction drops significantly for even a large data set.

Furthermore, an important assumption is made in the probability model in that the net effect of the second order interaction goes evenly to each of the two factors involved. Based on the Occam's Razor principle, this is the minimal assumption we need to make without any data evidence to suggest otherwise. Focusing on the first and second order terms also helps to reduce any assumption to a minimum. For example, trying to split the effect in the third order interactions can be more hazardous than in the second order interactions.

Both the bagged logistic regression model and the probabilistic model are employed to analyze the same advertising campaign data set for overall attribution results across all main media channels. Results show that, while there are small differences, the general conclusion is consistent between the two models.

One reason that we consider more than one model is the following:

Digital advertising relies on a fair amount of subjectivity. Having two different modeling approaches give the advertiser the flexibility to choose. The bagged logistic regression model is more accurate and more flexible with a larger number of covariates. It is slightly more difficult to interpret. On the other hand, the probabilistic model is less accurate, but much more intuitive to interpret. In addition, the result from both models can cross validate the general conclusion reached in the overall advertising campaign analysis.

### Numerical Analysis

### Data Background

In the following discussion, we analyze a large advertising campaign data set using both proposed methods. This is a 2010 advertising campaign of a consumer software and services company. The campaign ran over a four week period. The size of the data set is over 300 GB compressed. We sampled one third, i.e. 72.5 million anonymous users. In total, these 72.5 million users received over two billion ad impressions coming from search, display, social, email, and video channels over a four week period. Because search advertising is priced using a pay-per-click model, only search clicks are reported for each user. Furthermore, more than a dozen advertising networks or equivalent media buying channels are involved in delivering identically designed advertisements. In our study, there are 39 channels in total. It is an unresolved but critically important problem for the advertiser to determine the true effectiveness of each media buying channel. This attribution analysis is not only important for ranking the effectiveness of the channels, but also in deriving insights so that different optimization tactic can be deployed under different circumstances. We apply the bagged logistic regression model and the simple probabilistic model to analyze this data.

### Bagged Logistic Regression Analysis

In the following discussion we examine the empirical performance of the bagged logistic regression model and compare it with the usual logistic regression using the V-A-metric. In addition, we also examine the choice of the tuning parameters in the bagged logistic regression. The simulation setup is based upon the following scheme:

Step 1. Randomly sample a subset of N users as the training data. We choose N=50,000, and the ratio between the active and inactive users is 1:4. This leads to 10,000 randomly selected active users and 40,000 inactive users. Note that the results for the ratio of 1:1 are very similar, but are omitted for brevity.
Step 2. Randomly sample another independent subset of N users as the testing data.
Step 3. Fit the bagged logistic regression to the training data, with the pre-specified sample proportion pₛ and the covariate proportion p_{c}, and obtain the coefficient estimate.
Step 4. Fit the usual logistic regression to the training data, and obtain the coefficient estimate.
Step 5. Evaluate the misclassification error rate of both regression models on the testing data.
Step 6. Repeat Steps 1 to 5 for S=100 times. Compute the V-A-metric for both regression models. Because each sampling is random, all data have chance of being selected as training or testing data.

We set the sample proportion as pₛ=0.25, 0.5 and 0.75, and the covariate proportion as p_{c}=0.25, 0.5 and 0.75, respectively. Table 1 reports the results. It is seen from Table 1 below that, when pₛ and p_{c} are both close to zero, the bagged logistic model achieves a substantially smaller V-metric but also a worse A-metric compared to the usual logistic model.

TABLE 1
Comparison of the bagged logistic regression (BLR) and the usual
logistic regression (LR) in terms of the V-A-metric

| | | | P_{c} | | | | | |
|---|---|---|---|---|---|---|---|---|
| | | | 0.25 | | 0.50 | | 0.75 | |
| | | | V-metric | A-metric | V-metric | A-metric | V-metric | A-metric |
| Pₛ | 0.25 | LR | 2.053 | 0.091 | 1.934 | 0.091 | 2.006 | 0.091 |
| | | BLR | 0.257 | 0.142 | 0.688 | 0.093 | 0.824 | 0.091 |
| | 0.50 | LR | 1.913 | 0.091 | 2.115 | 0.091 | 1.972 | 0.091 |
| | | BLR | 0.284 | 0.147 | 0.672 | 0.093 | 1.039 | 0.091 |
| | 0.75 | LR | 1.868 | 0.091 | 2.053 | 0.091 | 1.968 | 0.091 |
| | | BLR | 0.327 | 0.147 | 0.743 | 0.093 | 1.294 | 0.091 |

When pₛ and p_{c} take some value in the middle range of zero and one, e.g. when pₛ=0.5 and p_{c}=0.5, it can be seen that the bagged model achieves a variability measure that is much smaller than the variability of the usual logistic model, whereas the accuracy measure of the two models become almost identical. As pₛ and p_{c} increase closer to one, the bagged model exhibits an A-metric that is essentially identical to that of the usual logistic model, but with a lower V-metric. As such, a presently preferred embodiment of the invention chooses pₛ and p_{c} to take values around 0.5 if both the variability and the accuracy are of the concern. For the number of iterations M, we have experimented with a number of values and observe the same qualitative patterns. For brevity, we only report in Table 1 the results based on M=1000 iterations. We also note that the V-metric for the usual logistic regression varies a little although it does not depend on the varying parameters pₛ and p_{c}. This is due to the random sampling variation, which to some extent reflects how variable the usual logistic model can be for the advertising data. Even a random subset of samples would cause visible estimation variation.

### Probabilistic Model Analysis

We next apply the simple probabilistic model to the same data set, and we evaluate the model with the V-A-metric. The resulting V-metric is 0.026, whereas the A-metric is 0.115. Comparing with the results in Table 1, we see that the probabilistic model achieves a very low variability due to its deterministic logic and simple model structure. On the other hand, its misclassification rate is higher than the bagged logistic model, which again is intuitively attributable to the low model complexity. These observations reflect the well known bias variance tradeoff. Although more complicated models, e.g. a higher order probabilistic model, could improve estimation accuracy, it would also induce higher variation. Besides, higher order models are often computationally infeasible for ad data of such a scale.

We also compare the bagged logistic regression model and the simple probabilistic model in terms of MTA user level assignment. For the bagged logistic model, we take the linear term \hat{β}′xᵢ as the contribution of the channel i, where \hat{β} denotes the coefficient estimate based on the bagged model.

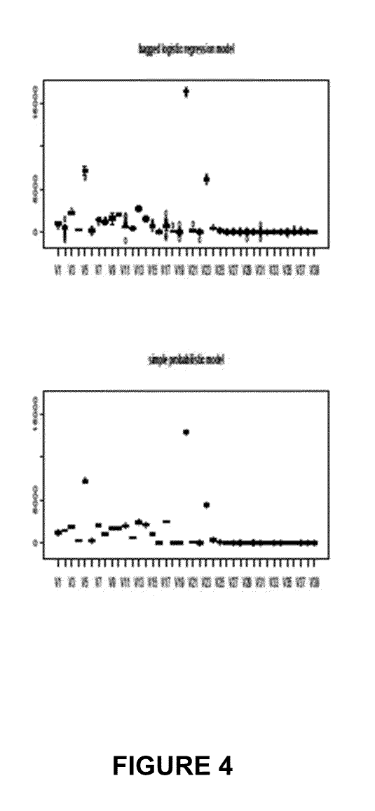

For the simple probabilistic model, we use equation (3) to compute user level assignment for each channel. We resample the data S=100 times, and show the box plot for the two models in FIG. 4, i.e. MTA user level assignment for the bagged logistic regression model and the simple probabilistic model.

First, we observe that the two models yield very similar patterns, suggesting a good agreement of the two models. Second, the bagged logistic regression model exhibits a relatively low variability across data resampling, whereas the simple probabilistic model shows a even smaller variability due to its model simplicity. For ease of comparison, we choose the simplest feature construction scheme for all the models, i.e. we only encode the presence of each channel as a binary variable. The actual model can take on more complex features, such as the creative design, website category, time of advertisement, frequency of the user's exposure to the same ad, among others. While the scaling constants are different, both proposed models have a computation complexity of O(p²N), where p is the number of dimensions and N is the data sample size.

### Interpretation of the Results

We presented the user level attribution analysis to an advertising team. Some interesting observations were made when comparing the MTA model with advertiser's existing LTA model. The comparison is shown in Table 2 for a subset of channels that are of particular interests to the advertising team. As seen from the table, for search click, email click, retail email click, and social click, MTA and LTA get very similar numbers. Essentially these types of user initiated responses are both highly correlated to the final purchase decision, and temporally occurring very close to the purchase decision.

TABLE 2
MTA User-Level Attribution Analysis

| Channel | MTA Total | LTA Total | Difference |
|---|---|---|---|
| Search Click | 17,494 | 17,017 | 97% |
| Email Click | 6,938 | 7,340 | 106% |
| Display Network A | 5,567 | 8,148 | 146% |
| Display Network G | 2,037 | 470 | 23% |
| Display Network B | 1,818 | 1,272 | 70% |
| Display Trading Desk | 1,565 | 1,367 | 87% |
| Display Network C | 1,494 | 1,373 | 92% |
| Display Network D | 1,491 | 1,233 | 83% |
| Email View | 1,420 | 458 | 32% |
| Display Network E | 1,187 | 1,138 | 96% |
| Brand Campaign | 907 | 1,581 | 174% |
| Social | 768 | 1,123 | 146% |
| Display Network H | 746 | 284 | 38% |
| Display Network F | 673 | 787 | 117% |
| Display Network I | 489 | 136 | 28% |
| Retail Email Click | 483 | 491 | 102% |
| Display Network J | 222 | 92 | 41% |
| Retail Email | 168 | 110 | 66% |
| Social Click | 133 | 153 | 115% |
| Video | 58 | 31 | 54% |

On the other hand, the effectiveness of display ad networks is widely different. Overall, display ads (or banner ads) are undervalued by the LTA model because these ad impressions are usually further away in time from the purchase action than, e.g. search click. In addition, some ad networks (for example, Network G) are doing much better and some (for example, Network A) are doing much worse. This may be attributed to a trick some ad networks play in gaming the LTA model. It is called “cookie bombing” where large amount of low cost almost invisible ads are shown to large amount of users. While these impressions do not have much real influence on user's decision, they appear quite often as the last ad impression user “sees” and therefore gets the credit from LTA model.

Our models provided some important insights that helped the advertiser to gauge the true effectiveness of each media channel and root out those gaming tactics. By this change alone, it is estimated that the advertiser can improve the overall campaign performance by as much as 30%.

### Discussion

Two statistical multi-touch attribution models are disclosed herein. We also disclose a bivariate metric that can be used to evaluate and select a data driven MTA model. The main body of this work falls under descriptive or interpretive modeling, a field that has been largely ignored in comparison to predictive modeling. For digital advertising, having the right attribution model is critically important because it drives performance metric, advertising insights and optimization strategy.

Current state of the art attribution models are represented by Chandler Pepelnjak, Clearsaleing Inc., and C3 Metric, Inc., supra. When compared to our disclosed models, none of the existing publicized models are statistically derived from the advertising data in question. To apply those models, one needs either to rely on some universal rule that would result in identical assignment regardless of advertisers or user context, or one needs to come up with some subjective assignment rule based on human intuition. By contrast, the methods disclosed herein are data driven and are based upon the most relevant advertising data, and, as such, are more accurate and objective. The probabilistic model is the industry's first data-driven multi-touch attribution model.

While both methods are statistically sound, to make MTA models useful for digital advertising requires additional heuristics in the following areas:

1. Select the right dimensions to model on. Introducing unnecessary dimensions would introduce noise and make results difficult to interpret.
2. Control the dimensionality and cardinality. Higher dimensionality and cardinality would either significantly increase the amount of data needed for statistical significance or drown out the important conclusions.
3. Carefully encode variables so that domain knowledge could help choose a compact yet effective model.

There are a number of embodiments of the invention. First, the bagging process is a wrapper method that can be applied to many types of learning machines. For am embodiment, we chose logistic regression for the ease of implementation and the simple interpretation of the coefficients. One can extend this MTA framework to other learning machines so that we can choose a more powerful learning method, while still being able to derive the user level attribution assignment easily.

Another embodiment concerns formalizing the heuristics needed for building specific types of MTA models that can address typical digital advertising questions, such as budget allocation, cross-channel optimization, and message sequencing.

A third area is in incorporating the MTA model into predictive advertising models. Attribution models define the success metric of each advertising campaign. Because of the dominance of the LTA model, many predictive models used today are influenced by it. New predictive models are needed when advertisers start to adopt the new attribution model.

### Computer Implementation

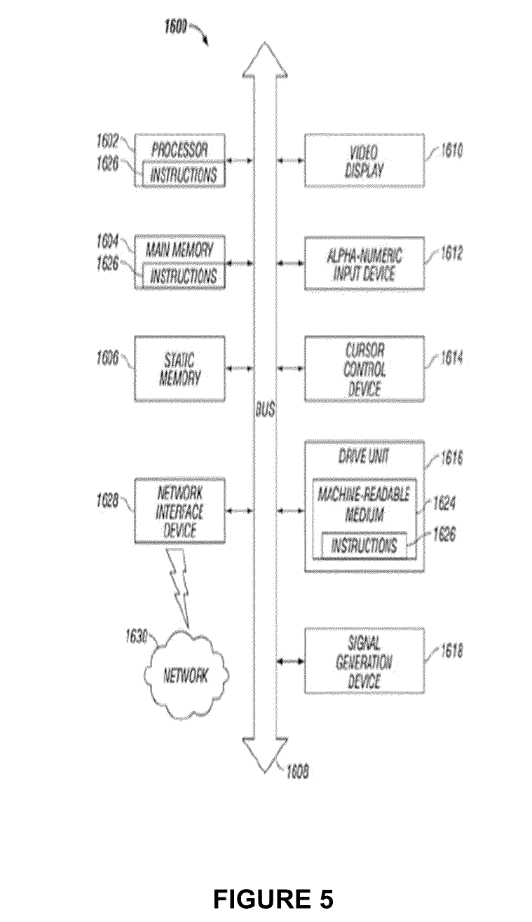

FIG. 5 is a block schematic diagram that depicts a machine in the exemplary form of a computer system 1600 within which a set of instructions for causing the machine to perform any of the herein disclosed methodologies may be executed. In alternative embodiments, the machine may comprise or include a network router, a network switch, a network bridge, personal digital assistant (PDA), a cellular telephone, a Web appliance or any machine capable of executing or transmitting a sequence of instructions that specify actions to be taken.

The computer system 1600 includes a processor 1602, a main memory 1604 and a static memory 1606, which communicate with each other via a bus 1608. The computer system 1600 may further include a display unit 1610, for example, a liquid crystal display (LCD) or a cathode ray tube (CRT). The computer system 1600 also includes an alphanumeric input device 1612, for example, a keyboard; a cursor control device 1614, for example, a mouse; a disk drive unit 1616, a signal generation device 1618, for example, a speaker, and a network interface device 1628.

The disk drive unit 1616 includes a machine readable medium 1624 on which is stored a set of executable instructions, i.e., software, 1626 embodying any one, or all, of the methodologies described herein below. The software 1626 is also shown to reside, completely or at least partially, within the main memory 1604 and/or within the processor 1602. The software 1626 may further be transmitted or received over a network 1630 by means of a network interface device 1628.

In contrast to the system 1600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g., a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer implemented method for multi-touch attribution determination in a multichannel advertising campaign, comprising:
with a processor, executing program instructions that implement a bivariate metric in which a first variable measures variability of an estimate of an individual's advertising channel contributions to a conversion event, and a second variable measures accuracy of classifying positive and negative users; and
with said processor, effecting multi-touch attribution for said conversion event with said bivariate metric.

2. The method of claim 1, further comprising:
with said processor, applying a bagged logistic regression model to said bivariate metric for classification and determination of individual advertising channel contributions.

3. The method of claim 1, further comprising:
with said processor, applying an intuitive and simple probabilistic model to quantify attribution of different advertising channels directly.

4. The method of claim 1, further comprising:
with said processor, applying a bagged logistic regression model to said bivariate metric for classification and determination of individual advertising channel contributions; and
with said processor, applying an intuitive and simple probabilistic model to quantify attribution of different advertising channels directly.

5. The method of claim 1, further comprising:
obtaining a first random subset of samples of both positive and negative users as a training data set;
obtaining a second random subset as an independent testing data set;
fixing a ratio of positive versus negative users;
fitting a multi-touch attribution (MTA) model to the training data;
recording a contribution of each advertisement channel comprising a coefficient estimate from the fitted MTA model;
evaluating said fitted model on said independent testing data;
recording a misclassification error rate;
repeating said foregoing steps multiple times to compute a standard deviation of individual coefficients estimates across multiple repetitions;
reporting an average of all standard deviations across different channels as a variability measure (V-metric), and an average of misclassification error rates across data repetitions as a accuracy measure (A-metric); and
evaluating said MTA model based upon a bivariate metric of both said variability measure and said accuracy measure (V-A-metric);
wherein a small A-metric indicates that a model under investigation has a high accuracy of predicting an active or inactive user, while a small V-metric indicates that said model has a stable estimate.

6. The method of claim 2, further comprising:
for a given data set, sampling a proportion pₛ of all sample observations and a proportion p_{c} of all covariates;
fitting a logistic regression model on said sampled covariates and said sampled data;
recording said estimated coefficients;
repeating said forgoing steps for M iterations;
taking a final coefficient estimate for each covariate as an average of estimated coefficients in M iterations;
wherein said sample proportion pₛ, said covariate proportion p_{c}, and said number of iterations M comprise parameters of said bagged logistic regression.

7. The method of claim 3, comprising:
for a given data set, computing an empirical probability of main factors,
$$P ( y \vert {x}_{i} ) = \frac{{N}_{positive} ( {X}_{i} )}{{N}_{positive} ( {X}_{i} ) + {N}_{negative} ( {X}_{i} )}$$
and pairwise conditional probabilities,
$$P ( y \vert {x}_{i} {x}_{j} ) = \frac{{N}_{positive} ( {x}_{i} , {x}_{j} )}{{N}_{positive} ( {x}_{i} , {x}_{j} ) + {N}_{negative} ( {x}_{i} , {x}_{j} )}$$
for i≠j, where, y is a binary outcome variable denoting a conversion event, xᵢ, i=1, . . . , p, denote p different advertising channels, Nₚₒₛᵢₜᵢᵥₑ(xᵢ) and N_{negative}(xᵢ) denote a number of positive or negative users exposed to channel i, respectively, and Nₚₒₛᵢₜᵢᵥₑ(xᵢ, xⱼ) and N_{negative}(xᵢ, xⱼ) denote a number of positive or negative users exposed to both channels i and j;
computing a contribution of channel i at each positive user level as:
$$C ( {x}_{i} ) = p ( y \vert {x}_{i} ) + \frac{1}{2 {N}_{j \neq i}} {\sum }_{j \neq i} \{ p ( y \vert {x}_{i} , {x}_{j} ) - p ( y \vert {x}_{i} ) - p ( y \vert {x}_{j} ) \}$$
where Nⱼ≠i denotes a total number of j's not equal to i.

8. An apparatus for multi-touch attribution determination in a multichannel advertising campaign, comprising:
a processor executing program instructions that implement a bivariate metric in which a first variable measures variability of an estimate of an individual's advertising channel contributions to a conversion event, and a second variable measures accuracy of classifying positive and negative users, said processor effecting multi-touch attribution for said conversion event with said bivariate metric.

9. The apparatus of claim 8, further comprising:
said processor applying a bagged logistic regression model to said bivariate metric for classification and determination of individual advertising channel contributions.

10. The apparatus of claim 8, further comprising:
said processor applying an intuitive and simple probabilistic model to quantify attribution of different advertising channels directly.

11. The apparatus of claim 8, further comprising:
said processor applying a bagged logistic regression model to said bivariate metric for classification and determination of individual advertising channel contributions; and
said processor applying an intuitive and simple probabilistic model to quantify attribution of different advertising channels directly.

12. The apparatus of claim 8, further comprising, said processor:
obtaining a first random subset of samples of both positive and negative users as a training data set;
obtaining a second random subset as an independent testing data set;
fixing a ratio of positive versus negative users;
fitting a multi-touch attribution (MTA) model to the training data;
recording a contribution of each advertisement channel comprising a coefficient estimate from the fitted MTA model;
evaluating said fitted model on said independent testing data;
recording a misclassification error rate;
repeating said foregoing steps multiple times to compute a standard deviation of individual coefficients estimates across multiple repetitions;
reporting an average of all standard deviations across different channels as a variability measure (V-metric), and an average of misclassification error rates across data repetitions as a accuracy measure (A-metric); and
evaluating said MTA model based upon a bivariate metric of both said variability measure and said accuracy measure (V-A-metric);
wherein a small A-metric indicates that a model under investigation has a high accuracy of predicting an active or inactive user, while a small V-metric indicates that said model has a stable estimate.

13. The apparatus of claim 9, further comprising said processor:
for a given data set, sampling a proportion pₛ of all sample observations and a proportion p_{c} of all covariates;
fitting a logistic regression model on said sampled covariates and said sampled data;
recording said estimated coefficients;
repeating said forgoing steps for M iterations;
taking a final coefficient estimate for each covariate as an average of estimated coefficients in M iterations;
wherein said sample proportion pₛ, said covariate proportion p_{c}, and said number of iterations M comprise parameters of said bagged logistic regression.

14. The apparatus of claim 10, comprising said processor:
for a given data set, computing an empirical probability of main factors,
$$P ( y \vert {x}_{i} ) = \frac{{N}_{positive} ( {X}_{i} )}{{N}_{positive} ( {X}_{i} ) + {N}_{negative} ( {X}_{i} )}$$
and pairwise conditional probabilities,
$$P ( y \vert {x}_{i} {x}_{j} ) = \frac{{N}_{positive} ( {x}_{i} , {x}_{j} )}{{N}_{positive} ( {x}_{i} , {x}_{j} ) + {N}_{negative} ( {x}_{i} , {x}_{j} )}$$
for i≠j, where, y is a binary outcome variable denoting a conversion event, xᵢ, i=1, . . . , p, denote p different advertising channels, Nₚₒₛᵢₜᵢᵥₑ(xᵢ) and N_{negative}(xᵢ) denote a number of positive or negative users exposed to channel i, respectively, and Nₚₒₛᵢₜᵢᵥₑ(xᵢ, xⱼ) and N_{negative}(xᵢ, xⱼ) denote a number of positive or negative users exposed to both channels i and j;
computing a contribution of channel i at each positive user level as:
$$C ( {x}_{i} ) = p ( y \vert {x}_{i} ) + \frac{1}{2 {N}_{j \neq i}} {\sum }_{j \neq i} \{ p ( y \vert {x}_{i} , {x}_{j} ) - p ( y \vert {x}_{i} ) - p ( y \vert {x}_{j} ) \}$$
where Nⱼ≠i denotes a total number of j's not equal to i.
